(19) United States
(12) Patent Application Publication
(10) Pub. No.: US 2003/0209936 A1
(43) Pub. Date: Nov. 13, 2003

(54) Spoke engaging structure for tubeless rims

(76) Inventor: Lai-Chien Chen, Chang Hua Hsien (TW)

Correspondence Address: CHARLES E. BAXLEY, ESQUIRE, Fifth Floor, 59 John Street, New York, NY, 10038, US

(21) Appl. No.: 10/412,921

(22) Filed: Apr. 14, 2003

(30) Foreign Application Priority Data
May 10, 2002 (TW) 91206874

(51) Int. Cl. B60B 1/02

(52) U.S. Cl. 301/58

(57) ABSTRACT

A tubeless rim includes elongate apertures defined through an inner part thereof and each spoke has an elongate head which is inserted through the aperture and rotated 90 degrees so as to fix the head in a groove in a back of the inner part of the rim.

### FIELD OF THE INVENTION

The present invention relates to a rim and more particularly, to a tubeless rim which has elongate apertures defined through an inner part thereof and each spoke has an elongate head which is inserted through the aperture and rotated 90 degrees so as to fix the head in a groove in a back of the inner part of the rim.

### BACKGROUND OF THE INVENTION

A conventional tubeless rim 10 is shown in FIG. 6 and generally includes an outer part and an inner part. Two aligned holes 11, 110 are respectively defined through the inner part and the outer part such that a spoke 12 is inserted through the hole 11 in the inner part. A nut 13 is inserted through the hole 110 in the outer part so as to be threadedly connected to a threaded section 14 on an end of the spoke 12 as shown in FIG. 7. In order to seal the hole 110 so that a tire can be engaged with two lips extending from the rim 10, a rubber seal 15 is attached to an outer side of the outer part to seal the hole 110. It has degree of difficulties to seal the hole 110 perfectly by the seal 15. Leakage could be found from the holes 110 and along two sides of the seal 15. Besides, the nuts 13 can only be operated when the tire is not yet connected to the two lips and this also makes the maintenance of spokes 12 be difficult because the tire has to be removed from the rim 10.

The present invention intends to provide a rim that has apertures defined through the inner part and no hole is needed to be defined through the outer part.

### SUMMARY OF THE INVENTION

In accordance with one aspect of the present invention, there is provided a tubeless rim which comprises an inner part and an outer part. Two lips extend from two sides of the inner part. A plurality of apertures are defined through the inner part and a groove is defined in a back of the inner part and communicates with the apertures. A plurality of spokes each have a head which is extended through the apertures and rotated to be engaged with the groove.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a section of a rim and spokes of the present invention;

FIG. 2 shows the head of the spoke is inserted in the aperture in the inner part of the rim of the present invention;

FIG. 3 shows the head of the spoke is rotated 90 degrees to be engaged with a groove;

FIG. 4 is a plan view to show that the head of the spoke is rotated 90 degrees to be engaged with a groove;

FIG. 5 shows the apertures are located alternatively in the inner part of the rim;

FIG. 6 shows a section of a conventional rim and a spoke to be connected with a nut, and

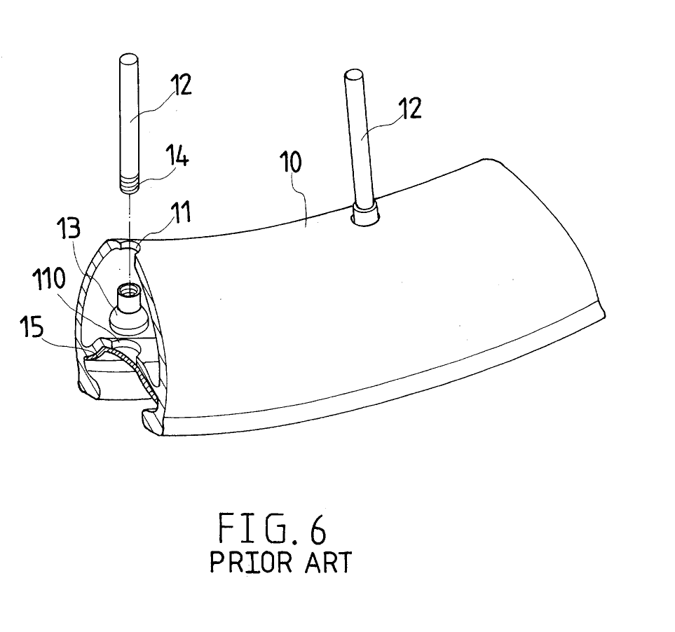

FIG. 7 is a cross sectional view to show the conventional rim and the spoke is connected with the nut.

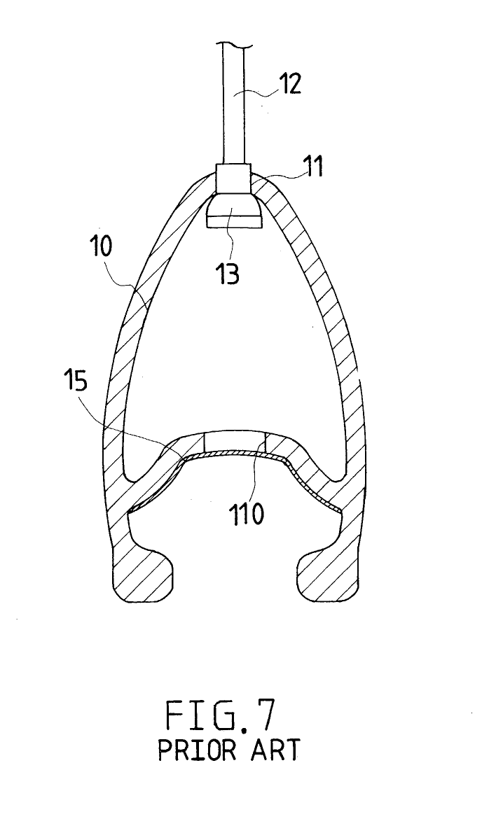

### DETAILED DESCRIPTION OF THE PREFERRED EMBODIMENT

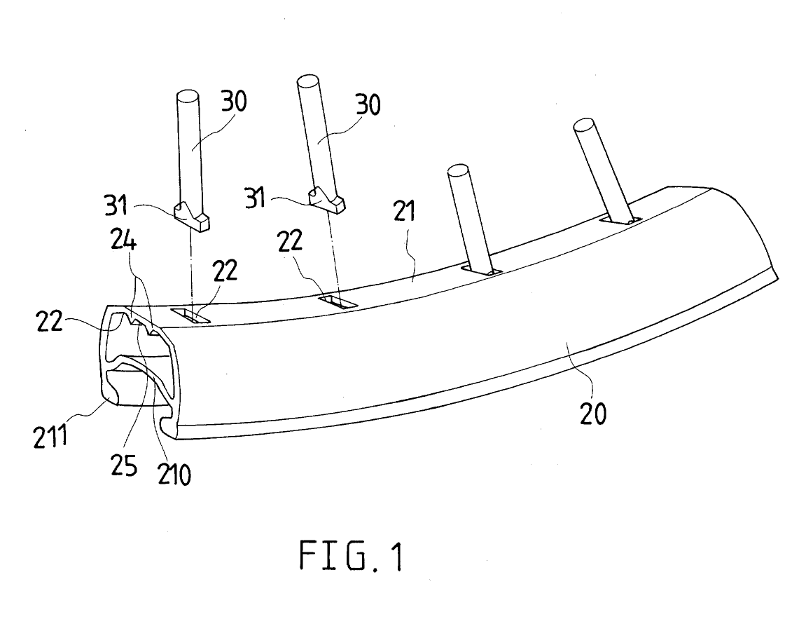

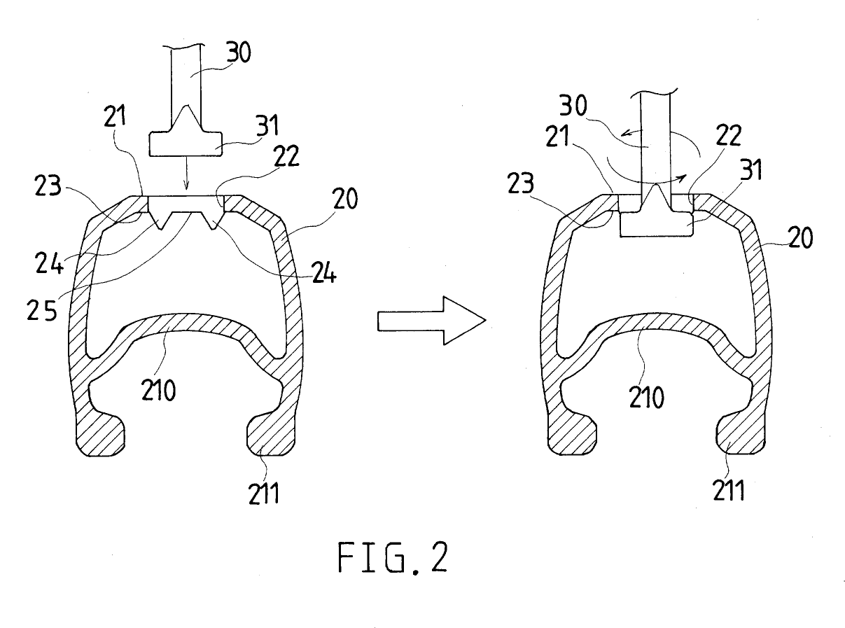

Referring to FIGS. 1 and 2, the tubeless rim 20 of the present invention comprises an inner part 21 and an outer part 210. Two lips 211 extend from two sides of the inner part 21 and extend beyond the outer part 210 so as to engage with a tire which is not shown. A plurality of elongate apertures 22 are defined through the inner part 21 and two ridges 24 extend from a back of the inner part 21 so as to define a groove 25 between the two ridges 24. The two ridges 24 are ended between any two consecutive apertures 22.

A plurality of spokes 30 each have an elongate head 31 at an end thereof, wherein a longitudinal length of each head 31 is longer than a width of the groove 25, and a width of each head 31 is the same as a width of the groove 25.

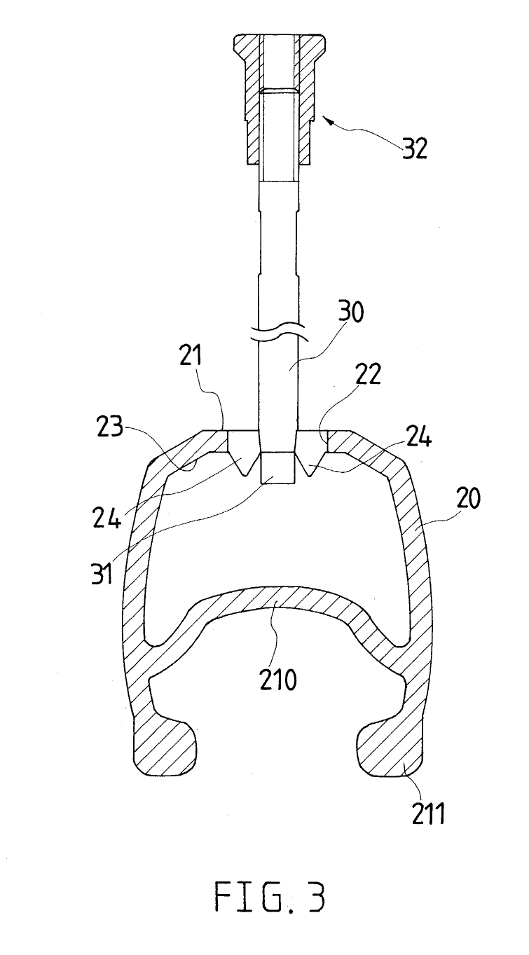

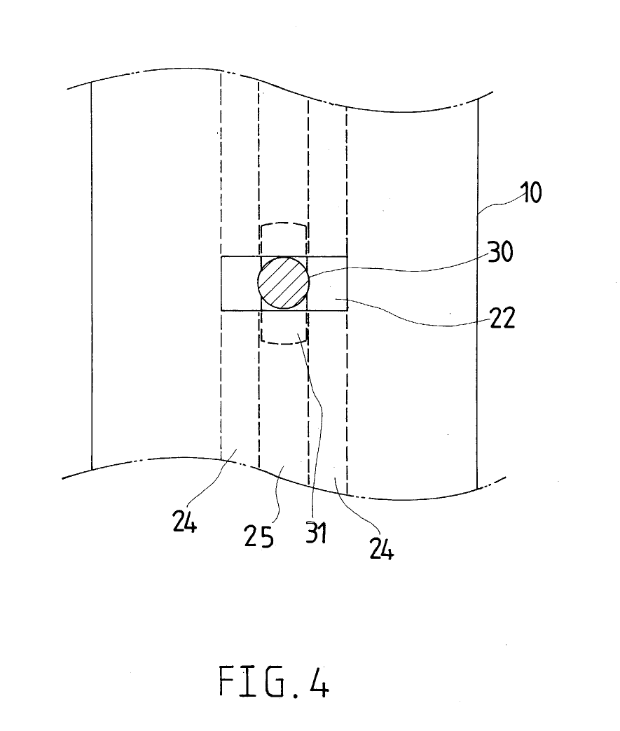

Further referring to FIGS. 3 and 4, the heads 31 are respectively extended through the apertures 22 and rotated 90 degrees to be engaged with the groove 25. A nut 32 is then threadedly connected to the other end of each spoke 30 to pull the spoke 30 in position.

It is to be noted that there is no hole needed in the outer part 210 of the rim 20 and no nut is needed to be received between the outer part 21 and the inner part 210 of the rim. The adjustment for the spokes 30 can be conveniently made without requiring removal of the tire. Because no hole is drilled through the outer part 210, leakage is effectively prevented from the outer part 210 as described in the conventional rim.

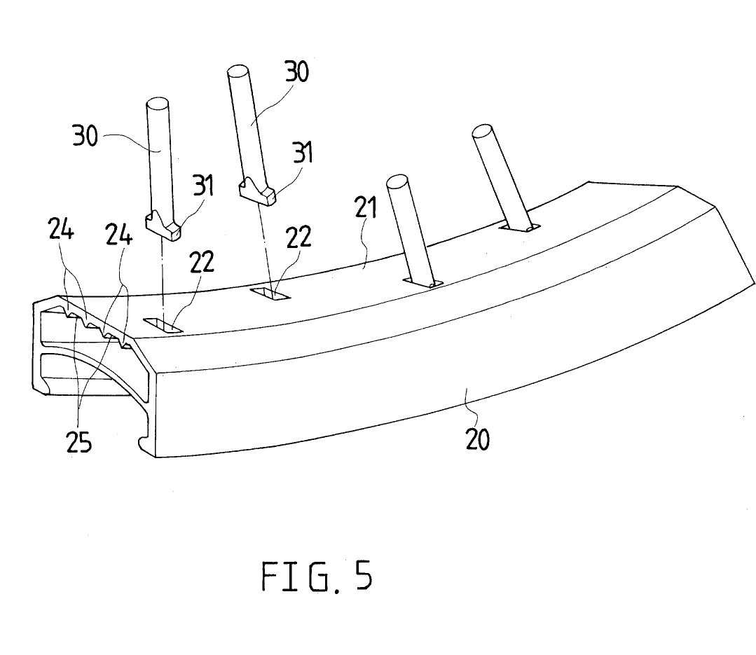

Referring to FIG. 5, the positions of the apertures 22 can be arranged to be alternative with each other as shown and two grooves 25 defined by two pairs of ridges 24 are defined in the back of the outer part 21 for positioning the respective heads 31 of the spokes 30.

While we have shown and described the embodiment in accordance with the present invention, it should be clear to those skilled in the art that further embodiments may be made without departing from the scope of the present invention.

What is claimed is:

1. A tubeless rim comprising:
an inner part and an outer part, two lips extending from two sides of the inner part, a plurality of apertures defined through the inner part and a groove defined in a back of the inner part and communicating with the apertures, and a plurality of spokes each having a head which is extended through the apertures and rotated to be engaged with the groove.

2. The tubeless rim as claimed in claim 1, wherein each head is an elongate head and each aperture is an elongate aperture, a longitudinal length of each head being longer than a width of the groove, and a width of each head being the same as a width of the groove.

3. The tubeless rim as claimed in claim 1, wherein two ridges extend from the underside of the inner part and are ended between two consecutive apertures, the groove defined between the two ridges.
